(19) United States
(12) Patent Application Publication
(10) Pub. No.: US 2025/0118877 A1
(43) Pub. Date: Apr. 10, 2025

(54) BIPOLAR BATTERY

(71) Applicant: Lasagna.one Inc., San Jose, CA (US)

(72) Inventors: Yuki Katoh, Santa Clara, CA (US); Xi Lin, San Jose, CA (US); Akinari Ohashi, Santa Clara, CA (US); Sarah Gabrielle Chavez, San Francisco, CA (US)

(73) Assignee: Lasagna.one Inc., San Jose, CA (US)

(21) Appl. No.: 18/809,612

(22) Filed: Aug. 20, 2024

Related U.S. Application Data
(60) Provisional application No. 63/542,587, filed on Oct. 5, 2023.

(51) Int. Cl. H01M 50/586; H01M 4/02; H01M 4/70; H01M 50/105; H01M 50/178

(52) U.S. Cl. CPC H01M 50/586; H01M 4/70; H01M 50/105; H01M 50/178; H01M 2004/029

(57) ABSTRACT

A bipolar stacked battery has a plurality of bipolar electrodes. Each of the bipolar electrodes has a current collector. A cathode layer containing a cathode active material is formed on a first surface of the current collector. An anode layer containing an anode active material is formed on a second surface of the current collector. A separator layer is formed on the cathode layer and the anode layer, wherein the separator layer extends past opposing side edges of the cathode layer and the anode layer. An insulator is formed on exposed side edges on at least one side of the current collector and extends past the current collector. A pair of terminal stacks is provided, wherein one of the pair of terminal stacks is formed at a higher voltage side of the bipolar stacked battery and a second of the pair of terminal stacks is formed on a lower voltage side of the bipolar stacked battery.

### RELATED APPLICATIONS

This patent application is related to U.S. Provisional Application No. 63/542,587 filed Oct. 5, 2023, entitled “BIPOLAR BATTERY”, in the names of the present inventors and which is incorporated herein by reference in its entirety. The present patent application claims the benefit under 35 U.S.C § 119(e) of the aforementioned provisional application.

### TECHNICAL FIELD

This disclosure generally relates to batteries, more particularly, to a bipolar battery.

### BACKGROUND OF THE INVENTION

Electric vehicles (EVs) have become increasingly prevalent in the market as an alternative to traditional internal combustion vehicles, largely due to their environmentally friendly nature and advanced technological features. The operation of electric vehicles heavily relies on their battery systems, which provide the necessary electrical energy to power the motors.

Conventionally, in order to generate sufficient voltage to operate high torque motors in vehicles, a large number of batteries are connected in series. However, this design has several inherent drawbacks. One drawback, for example, is that the stacking of batteries in series necessitates a significant number of joint parts. Joint parts not only contribute to a loss of energy density and power density due to volumetric loss, but they also introduce additional resistance, leading to a decrease in power density. Moreover, joint parts tend to focus current around the jointed areas, resulting in inhomogeneous temperature and current distribution across the batteries. This can ultimately contribute to the premature degradation of the battery system.

To address these challenges, bipolar batteries have been developed. In these bipolar batteries, a positive electrode and a negative electrode are arranged on both sides of a collector, significantly reducing the need for joint parts.

However, these bipolar batteries come with their own set of problems. Specifically, they present a risk of shortage: if current collectors from different layers come into contact, the battery cells fail to exhibit the necessary voltage, leading to lower overall voltage. Similarly, if the electrolytes of different battery layers touch, the cells likewise fail to produce the required voltage.

Some have used separators made of inorganic solid electrolyte to avoid electrical short circuits. This particular method involves covering the current collector with an insulating polymer to prevent electrical short circuits. This approach, however, still leaves open the risk of ionic short circuits. Specifically, if the electrolyte collapses due to external shock, the separator may generate small particles, causing the electrolytes of different layers to come into contact and resulting in an ionic short circuit. The separator, in that case, is not covered, which leaves it vulnerable to these issues. Therefore, a need exists to provide a bipolar battery that helps to prevent a short circuit in bipolar stacked cells.

### SUMMARY OF THE INVENTION

This summary is provided to introduce a selection of concepts in a simplified form that are further described below in the DETAILED DESCRIPTION OF THE INVENTION. This summary is not intended to identify key features of the claimed subject matter, nor is it intended to be used as an aid in determining the scope of the claimed subject matter.

In accordance with one embodiment of the present invention, a bipolar stacked battery is disclosed. The bipolar stacked battery has a plurality of bipolar electrodes. Each of the bipolar electrodes has a current collector. A cathode layer containing a cathode active material is formed on a first surface of the current collector. An anode layer containing an anode active material is formed on a second surface of the current collector. A separator layer is formed on the cathode layer and the anode layer, wherein the separator layer extends past opposing side edges of the cathode layer and the anode layer. An insulator is formed on exposed side edges on at least one side of the current collector and extends past the current collector. A pair of terminal stacks is provided, wherein one of the pair of terminal stacks is formed at a higher voltage side of the bipolar stacked battery and a second of the pair of terminal stacks is formed on a lower voltage side of the bipolar stacked battery.

In accordance with one embodiment of the present invention, a bipolar stacked battery is disclosed. The bipolar stacked battery has a plurality of bipolar electrodes. Each of the bipolar electrodes has a current collector. A cathode layer containing a cathode active material is formed on a first surface of the current collector. A anode layer containing an anode active material is formed on a second surface of the current collector. A separator layer is formed on the cathode layer and the anode layer, wherein the separator layer extends past opposing side edges of the cathode layer and the anode layer. An insulator is formed on exposed side edges on at least one side of the current collector and extending past the current collector. A gap is formed between at least one of the anode layer and the insulator, the insulator formed on exposed areas on the first surface of the current collector where the anode layer is formed, wherein the separator is positioned within the gap between the anode layer and the insulator or between the cathode layer and the insulator, the insulator formed on exposed areas on the second surface of the current collector where the cathode layer is formed, wherein the separator is positioned within the gap between the cathode layer and the insulator.

### BRIEF DESCRIPTION OF THE DRAWINGS

The present application is further detailed with respect to the following drawings. These figures are not intended to limit the scope of the present application, but rather, illustrate certain attributes thereof.

FIG. 1 is a top view of an exemplary stacked cell in accordance with one embodiment of the disclosure;

FIG. 2 is a cross-sectional view of the exemplary stacked cell of FIG. 1, taken along line A-A′ in accordance with one embodiment of the disclosure;

FIG. 3 is a top view of a layer of the exemplary stacked cell of FIG. 1 in accordance with one embodiment of the disclosure;

FIG. 4 is a cross-sectional view of the exemplary layer of FIG. 3, taken along line A-A′ in accordance with one embodiment of the disclosure;

FIG. 5 is a top view of another exemplary layer of the stacked cell of FIG. 1 in accordance with one embodiment of the disclosure;

FIG. 6 is a cross-sectional view of the exemplary layer of FIG. 5, taken along line A-A′ in accordance with one embodiment of the disclosure;

FIG. 7 is a top view of another exemplary layer of the stacked cell of FIG. 1 in accordance with one embodiment of the disclosure;

FIG. 8 is a cross-sectional view of the exemplary layer of FIG. 7, taken along line A-A′ in accordance with one embodiment of the disclosure;

FIG. 9 is a cross-sectional view of an exemplary cathode terminal stack in accordance with one embodiment of the disclosure;

FIG. 10 is a cross-sectional view of another exemplary cathode terminal stack in accordance with one embodiment of the disclosure;

FIG. 11 is a cross-sectional view of an exemplary anode terminal stack in accordance with one embodiment of the disclosure;

FIG. 12 is a cross-sectional view of another exemplary anode terminal stack in accordance with one embodiment of the disclosure;

FIG. 13 is a front view of the exemplary stacked cell of FIG. 1 in accordance with one embodiment of the disclosure;

FIG. 14 is an exploded front view of the exemplary stacked cell of FIG. 13 in accordance with one embodiment of the disclosure;

FIG. 15 is a top view of an exemplary air-tight pouch in accordance with one embodiment of the disclosure;

FIG. 16 is a cross-sectional view of the exemplary air-tight pouch of FIG. 15 in accordance with one embodiment of the disclosure;

FIG. 17 is a top view of the exemplary air-tight pouch with the stacked cell contained therein in accordance with one embodiment of the disclosure;

FIG. 18 is a cross-sectional view of the exemplary air-tight pouch of FIG. 17 in accordance with one embodiment of the disclosure;

FIG. 19 is a top view of an exemplary battery casing with the stacked cell contained therein in accordance with one embodiment of the disclosure;

FIG. 20 is a cross-sectional view of the exemplary battery casing of FIG. 19 in accordance with one embodiment of the disclosure;

FIG. 21 is a cross-sectional view of an exemplary stacked cell in accordance with one embodiment of the disclosure;

FIG. 22 is a magnified view of the exemplary stacked cell of FIG. 21 in accordance with one embodiment of the disclosure;

FIG. 23 is a cross-sectional view of an exemplary stacked cell in accordance with one embodiment of the disclosure;

FIG. 24 is a cross-sectional view of an exemplary stacked cell in accordance with one embodiment of the disclosure;

FIG. 25 is a cross-sectional view of an exemplary stacked cell in accordance with one embodiment of the disclosure;

FIG. 26 is a magnified view of the exemplary stacked cell of FIG. 25 in accordance with one embodiment of the disclosure;

FIG. 27 a cross-sectional view of an exemplary stacked cell in accordance with one embodiment of the disclosure;

FIG. 28 is a cross-sectional view of an exemplary stacked cell in accordance with one embodiment of the disclosure;

FIG. 29 is a magnified view of the exemplary stacked cell of FIG. 28 in accordance with one embodiment of the disclosure;

FIG. 30 is a cross-sectional view of an exemplary stacked cell in accordance with one embodiment of the disclosure;

FIG. 31 is a graph showing a charge and discharge profile of an exemplary stacked cell in accordance with one embodiment of the disclosure; and

FIG. 32 is a graph showing a charge and discharge profile of an exemplary stacked cell in accordance with one embodiment of the disclosure.

### DETAILED DESCRIPTION OF THE INVENTION

The description set forth below is intended as a description of presently preferred embodiments of the disclosure and is not intended to represent the only forms in which the present disclosure can be constructed and/or utilized. The description sets forth the functions and the sequence of steps for constructing and operating the disclosure. It is to be understood, however, that the same or equivalent functions and sequences can be accomplished by different embodiments that are also intended to be encompassed within the spirit and scope of this disclosure.

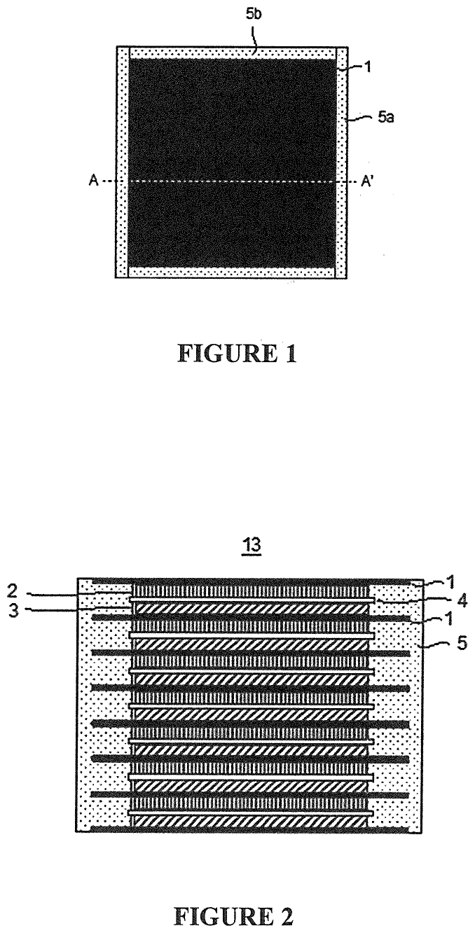

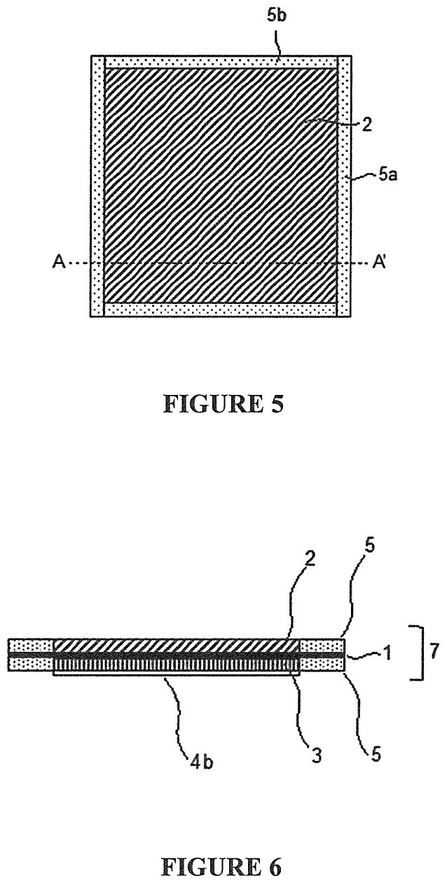

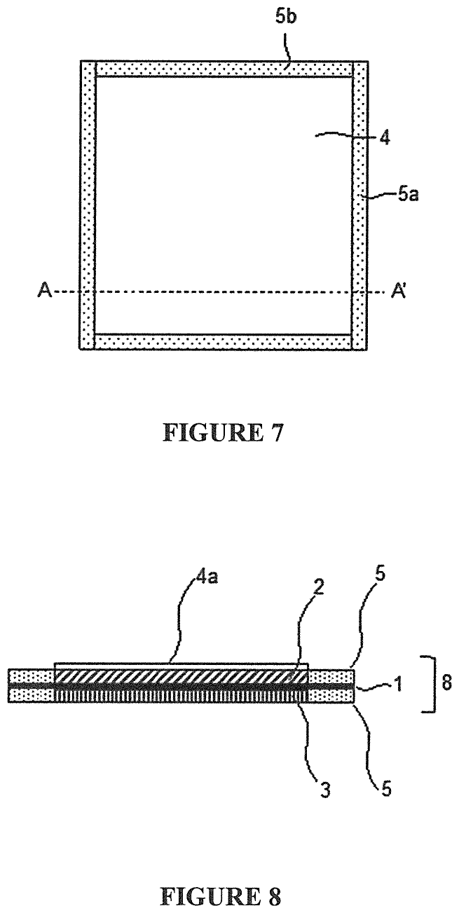

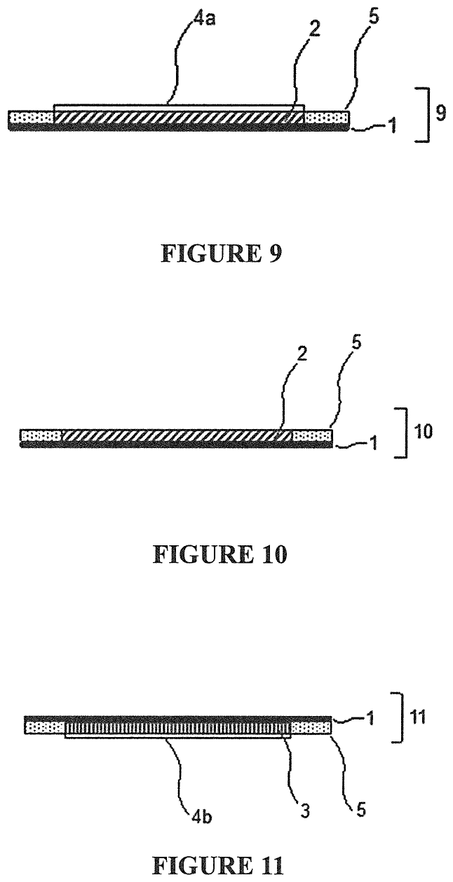

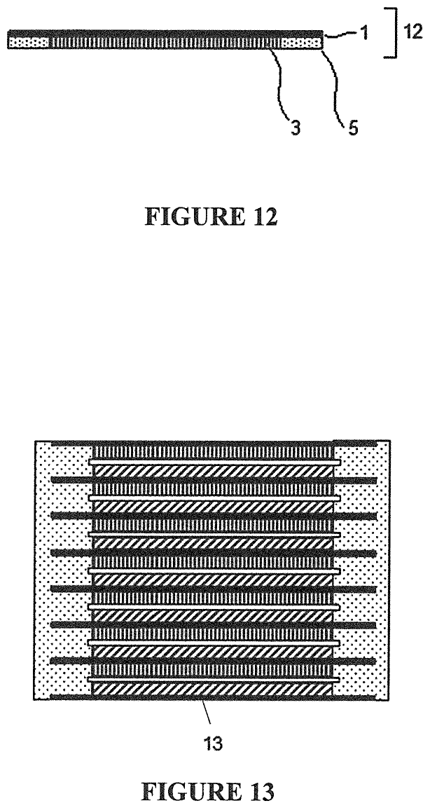

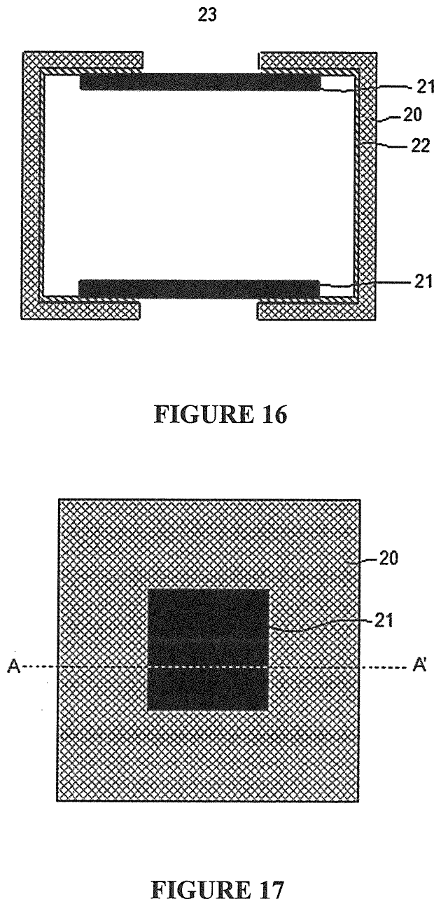

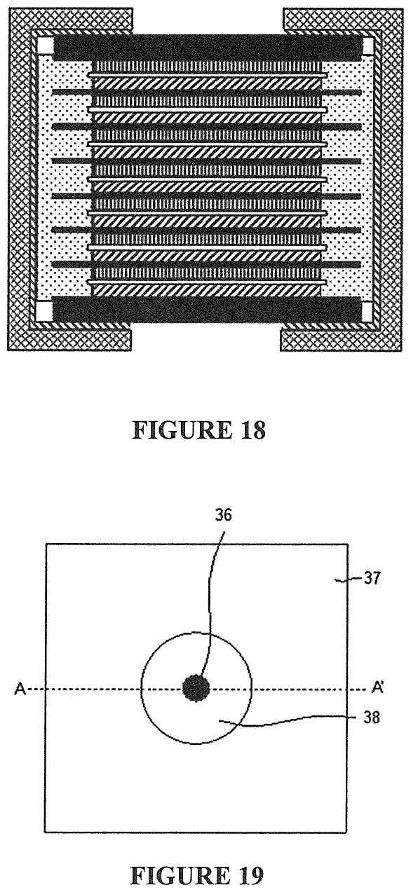

FIGS. 1-20 together show an embodiment of a bipolar battery of the present invention. In its simplest form, the bipolar battery comprises a stacked cell 13, an insulator 5 that covers the entire surface of electrode and separator 4 allowing for a much lower risk of an ionic short. In accordance with one embodiment, the components of the bipolar battery may be formed in an air-tight pouch 23, and a unique battery casing which has electric connector 36 in a concavity 38.

### Stacked Cell

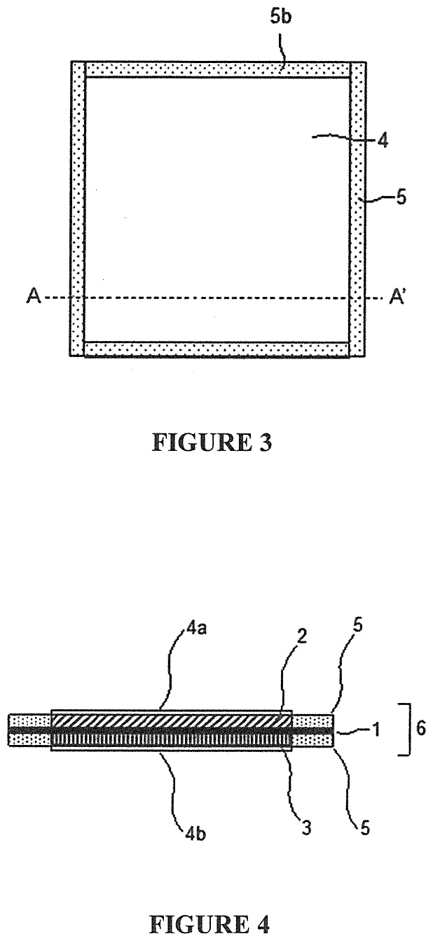

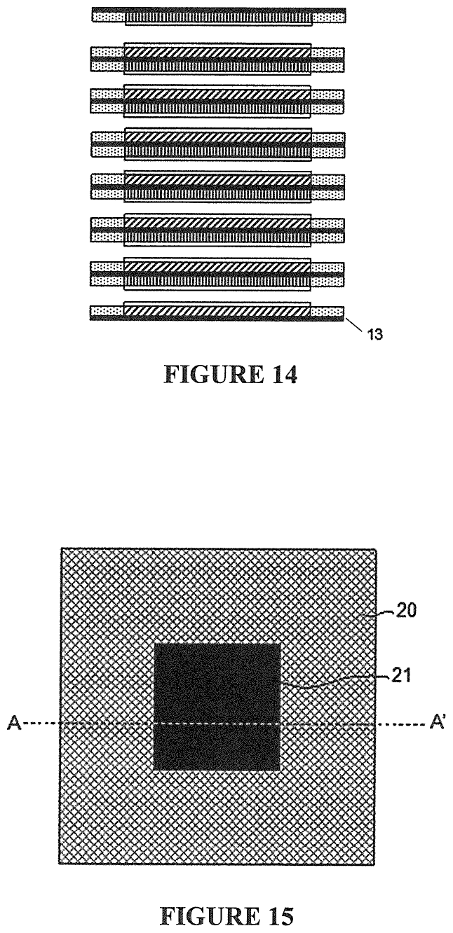

FIG. 1 shows a schematic of a stacked cell 13. FIGS. 3-12 schematically show the structure of layers of an electric element 6-12, which are components of the stacked cell 13. And FIGS. 13-14 show side views of the stacked cell 13.

At the terminal of the stack at the higher voltage side, an electric cathode terminal stack (either cathode terminal stack 9 or cathode terminal stack 10) is used depending on the position of separator 4. At the terminal of the stack at the lower voltage side, an anode terminal stack (either anode terminal stack 11 or anode terminal stack 12) is used depending on the position of separator 4. From the second layer counting from the terminal, the electric components 6, 7, 8 or a combination of those electric components 6, 7, 8 will be stacked. Each layer is laminated by separator 4. As the result, in the direction from the high voltage side to the low voltage side, the stacked cell 13 comprises the layer of the current collector 1, the cathode layer 2, the separator 4, the anode layer 3, the current collector 1, the cathode layer 2, the separator 4, the anode layer 3 and so on in this repeating order.

As shown in FIG. 1, the edge of the stack is covered by reinforcement which comprises an insulator 5. The insulator 5 does not have conductivity of either electrons or ions. As shown in FIG. 1 top view and FIG. 2 cross section, the reinforcement (insulator 5) covers the exposed edge of the current collector 1, the cathode layer 2, the anode layer 3, and the separator 4. Namely, none of the layers are contacting any of the other layers in/between the electric stacks. The side of the stack cell 13 is completely covered by the insulator 5 and none of the current collector 1, the cathode layer 2, the anode layer 3, nor the separator 4 is exposed to the edge of stacked cell 13.

The current collector 1 may be composed of metal foil, a metal mesh, or any other suitable material, while metal foil is preferable. Examples of metal that may be used in the current collector 1 include but are not limited to Cu, Ni, Cr, Au, Pt, Ag, Au, Al, Fe, Ti, Zn, Co and stainless steel. It can be the metal pure element, doped, alloy or clad. The surface of the metal may also be covered with carbon or other material. This will ensure good adhesion with the cathode layer 2 and the anode layer 3. In addition to metal, carbon may also be used for the current collector 1. Resin composites with an electron conductor (metal or carbon) as filler can also be used for the current collector 1. Possible carbon filler materials include acetylene black (AB), Ketjen black (KB), vapor grown carbon fiber (VGCF), carbon nanotubes, carbon nanohorns, and fullerenes. Possible filler metals include stainless steel, Cu, Ni, Cr, Au, Pt, Ag, Au, Al, Fe, Ti, Zn, Co. The shape of the filler may be spherical, fibrous, needle-like, or hollow. When needle or fiber-shaped fillers are used, it may be effective to make them oriented. This is because the orientation controls the flow of electrons and makes it easier to interrupt the current in the event of an abnormality.

The thickness of the current collector 1 may be of any suitable thickness. For example, the thickness of the current collector 1 is preferably between 0.1 um to 1 mm, and is more preferably between 1 μm to 50 um.

The cathode layer 2 is a layer containing at least a cathode active material (CAM). Examples of the CAM include, layered lithium containing oxide materials, such as LiCoO₂, LiMnO₂, LiNiO₂, LiNiₓMn_{y}Co_{1-x-y}O₂, LiNiₓCo_{y}Al_{1-x-y}O₂, lithium containing phosphate with olivine structure, such as LiFePO₄, LiFeₓMn₁₋ₓPO₄, LiMnPO₄, LiFeₓCo₁₋ₓPO₄, LiCoPO₄, lithium containing oxide materials with spinel structure, such as LiNi_{0.5}Mn_{1.5}O₄, LiMn₂O₄, lithium excess layered structured oxide, such as Li₂MnO₃, Li₂RuO₃, Li₂RuₓTi₁₋ₓO₃, Li₂RuₓSn₁₋ₓO₃, Li₂MnₓTi₁₋ₓO₃, Li₂MnₓSn₁₋ₓO₃, layered lithium containing sulfide materials, such as TiS₂, MoS₂, NbS₂, TaS₂, Sulfur, or lithium containing sulfide with Chevrel structure, such as LiCuₓMoS_{1-z}.

The surface of CAM may be coated by thin layer of materials (coating). Examples of coating include crystalline phase, such as Li₂ZrO₃, LiNbO₃, Li₃BO₃, Li₃B₁₁O₁₈, LiPO₃, Li₃PO₄, LiTi₂(PO₄)₃, LiZr(PO₄)₃, ZrO₂, B₂O₃, Al₂O₃, Nb₂O₅, EtOLi, MtOLi, LiOH, Li₂CO₃ and/or amorphous phase, such as metal alkoxide, metal phosphate. The cathode layer 2 may further contain solid electrolytes, binders, electron conductive additives, in addition to CAM. Examples of electrolytes include organic liquid, organic polymer, inorganic solids. Preferably, the electrolytes comprise inorganic solids because of a higher transference number of lithium compared to liquid and because of a higher ionic conductivity than organic polymer. Furthermore, inorganic solids are usually rigid and do not show liquidity which is preferred in order to build stacked cell 13 without ionic shorting.

Preferred examples of electrolytes include the materials of Li—P—O—N, Li—Si—O, Li—B—Si—O, Li—B—O, Li—C—B—O, Li—Al—Si—O, Li—Ti—Al—P—O, Li—Zr—Al—P—O, Li—La—Zr—O, Li—La—Ta—Zr—O, Li—La—Nb—Zr—O, Li-M-S (M is B, Al, Si, P, Zn, Ge, Zr, Sn or any combination of those), Li-M′-S—O (M′ is B, Al, Si, P, Zn, Ge, Zr, Sn or any combination of those), Li—P—S—X (X is F, Cl, Br or any combination of those), Li—P—S—O—X′ (X′ is F, Cl, Br or any combination of those), Li—B—H, Li—B—N—H, Li—B—H—O, Li—B—N—H—O, Li-M″-X″ (M is In, Zr, Sc, Ga, Nb, Ta or any combination of those; X″ is F, Cl, Br or any combination of those), Li-M″-X″—O (M″ is In, Zr, Sc, Ga, Nb, Ta or any combination of those; X″ is F, Cl, Br or any combination of those).

Examples of a binder that may be contained in the cathode layer 2 include butadiene rubber (BR), butyl rubber (IIR), acrylate butadiene rubber (ABR), polyvinylidene difluoride (PVDF), and Polytetrafluoroethylene (PTFE). Side chains of the binder may be modified by functional groups.

In addition, the cathode layer 2 may contain electron conductive additives. For example, various types of carbon may include acetylene black (AB), Ketjen black (KB), VGCF, carbon nanotubes, carbon nanohorns, and fullerenes.

The thickness of the cathode layer 2 is not specifically limited, but a thicker layer may be preferred when higher capacity is required. For example, the thickness of cathode layer 2 is preferably between 0.1 um to 1 mm, and is ideally between 60 μm to 500 um.

The anode layer 3 is a layer containing at least an anode active material (AAM). Examples of the AAM include, layered lithium containing sulfide materials, such as TiS₂, MoS₂, NbS₂, TaS₂, titanium containing oxides, such as, Li₄Ti₅O₁₂, TiₓNb_{y}O_{z}, LiₓTi₂(PO₄)₃, tungsten containing oxides, such as Nb₁₆W₅O₅₅, Nb₁₈W₁₆O₉₃, vanadium containing oxide, such as LiVO₂, Artificial carbon (or hard carbon), Graphite, Li-metal alloy, such as LiₓIn, LiₓSn, LiₓSi, LiₓGe, LiₓAl, or metallic lithium.

The anode layer 3 may further contain solid electrolytes, binders, electron conductive additives, in addition to AAM. Examples of electrolyte include organic liquid, organic polymer, inorganic solids. Preferably, the electrolyte comprises inorganic solids because of higher transference number of lithium compared to liquid and higher ionic conductivity than organic polymer. Furthermore, it is also because inorganic solids are usually rigid and do not show liquidity which is preferred to compose stacked cell 13 without ionic shorting.

Preferred examples of electrolyte include the materials those have composition of Li—P—O—N, Li—Si—O, Li—B—Si—O, Li—B—O, Li—C—B—O, Li—Al—Si—O, Li—Ti—Al—P—O, Li—Zr—Al—P—O, Li—La—Zr—O, Li—La—Ta—Zr—O, Li—La—Nb—Zr—O, Li-M-S (M is B, Al, Si, P, Zn, Ge, Zr, Sn or any combination of those), Li-M′-S—O(M′ is B, Al, Si, P, Zn, Ge, Zr, Sn or any combination of those), Li—P—S—X (X is F, Cl, Br or any combination of those), Li—P—S—O—X′ (X′ is F, Cl, Br or any combination of those), Li—B—H, Li—B—N—H, Li—B—H—O, Li—B—N—H—O, Li-M″-X″ (M″ is In, Zr, Sc, Ga, Nb, Ta or any combination of those; X″ is F, Cl, Br or any combination of those), Li-M″-X″—O (M″ is In, Zr, Sc, Ga, Nb, Ta or any combination of those; X″ is F, Cl, Br or any combination of those).

Examples of a binder that may be contained in the anode layer 3 include butadiene rubber (BR), butyl rubber (IIR), acrylate butadiene rubber (ABR), polyvinylidene difluoride (PVDF), Polytetrafluoroethylene (PTFE). Side chains of the binder may be modified by functional groups.

In addition, the anode layer 3 may contain electron conductive additives. For example, various types of carbon may include acetylene black (AB), Ketjen black (KB), VGCF, carbon nanotubes, carbon nanohorns, and fullerenes.

The thickness of the anode layer 3 is not specifically limited, but a thicker layer may be preferred when higher capacity is required. For example, the thickness of the anode layer 3 is preferably between 0.1 um to 1 mm, and is more preferably between 60 μm to 500 um.

The separator 4 is an electron insulator but an ionic conductor. The electrolyte can be either organic liquid, organic polymer or inorganic solid. If an organic based electrolyte (liquid or polymer) is chosen, the separator 4 might be porous membrane comprising polymers such as Polyethylene (PE), Polypropylene (PP) and any combination of those; the membrane is immersed by organic based electrolyte.

Preferably, separator 4 is comprised of inorganic solids because of higher transference number of lithium compared to liquid and higher ionic conductivity than organic polymer. This is also because inorganic solids are usually rigid and do not show liquidity which is preferred to compose stacked cell 13 without ionic shorting.

Examples of electrolyte include organic liquid, organic polymer, inorganic solids. Preferably, electrolytes are inorganic solids because of higher transference number of lithium compared to liquid and higher ionic conductivity than organic polymer. Which is also because inorganic solids are usually rigid and do not show liquidity which is preferred to compose the stacked sell 13 without ionic shorting. Preferred examples of electrolyte include the materials those have composition of Li—P—O—N, Li—Si—O, Li—B—Si—O, Li—B—O, Li—C—B—O, Li—Al—Si—O, Li—Ti—Al—P—O, Li—Zr—Al—P—O, Li—La—Zr—O, Li—La—Ta—Zr—O, Li—La—Nb—Zr—O, Li-M-S (M is B, Al, Si, P, Zn, Ge, Zr, Sn or combination of those), Li-M′-S—O(M′ is B, Al, Si, P, Zn, Ge, Zr, Sn or combination of those), Li—P—S—X (X is F, Cl, Br or combination of those), Li—P—S—O—X′ (X′ is F, Cl, Br or combination of those), Li—B—H, Li—B—N—H, Li—B—H—O, Li—B—N—H—O, Li-M″-X″ (M″ is In, Zr, Sc, Ga, Nb, Ta or combination of those; X″ is F, Cl, Br or combination of those), Li-M″-X″—O (M″ is In, Zr, Sc, Ga, Nb, Ta or combination of those; X″ is F, Cl, Br or combination of those).

The solid electrolyte layer may contain a binder in addition to the above-mentioned solid electrolyte material. Examples of a binder that may include butadiene rubber (BR), butyl rubber (IIR), acrylate butadiene rubber (ABR), polyvinylidene difluoride (PVDF), Polytetrafluoroethylene (PTFE). Side chains of the binder may be modified by functional groups.

The thickness of the separator 4 is not specifically limited, but a thinner layer may be preferred when higher capacity is required. For example, the thickness of separator 4 is preferably between 0.1 um to 1 mm, and is more preferably between 0.1 um to 50 um.

The electron and ion insulator 5 is made to enhance of insulation between layers and thus enable the stacked cell 13 to exhibit high voltage. It is intricately formed on the current collector 1, enveloping both its longer and shorter sides meticulously. Its very presence is to ensure that any surface area of the current collector 1, which remains unoccupied by the cathode layer 2 or anode layer 3, is fully shielded.

In terms of its electrical properties, the electron and ion insulator 5 is built to be an exceptional insulator. Its electric conductivity must fall below 10⁻⁸ S/cm, with a stricter and more desirable threshold being below 10⁻¹⁰ S/cm. This ensures that the insulator performs at its optimum, providing maximum protection against any undesirable electrical currents.

The position of the electron and ion insulator 5 is not bound by stringent restrictions. The guiding principle is that the current collector 1 should be comprehensively shielded. In practical terms, this might mean that the insulator 5 could grace both sides of the current collector—one side that faces the cathode layer 2 and the other that faces the anode layer 3.

While the exact area of the insulator 5 on the current collector's 1 surface is not strictly defined, it's essential for it to sufficiently cover any regions left exposed from the edge of the electrode active material layer. The key is for it to insulate the current collector's 1 surface electronically. Yet, it's vital to avoid the formation of the insulator 5 on either the cathode layer 2 or the anode layer 3. Such a placement could be problematic during the bonding process when creating the stacked cells 13. Overlaps between the electrode and insulator layers could create regions of uneven pressure. Such disparities in pressure could damage the current collector 1 or even the separator layer. Moreover, overlapping areas would naturally be bulkier than the mere edges of the electrode, compromising the insulator's sealing capabilities. Any laxity in sealing could lead to ionic shorting, with ion conductors possibly seeping or gliding out of the separator. In the direst of circumstances, direct contact between separator layers could induce an ionic short circuit, severely hampering the battery's functionality.

The gap or distance between the cathode layer 2 and the insulator 5, denoted as width (r) of the bare surface of the current collector 1, should be carefully calibrated to ensure insulation between layers. It is not limited by rigid parameters, but the width r should ideally span a range from 0.0001% to 10% of the square root of S, where S represents the area of the cathode layer 2, measured in cm². This ensures a balanced design, offering optimum insulation while maintaining the structural integrity and performance of the battery. The gap or distance criteria between cathode layer 2 and insulator 5 is applicable to those between anode layer 3 and insulator 5.

The materials used for the electron and ion insulator 5 is not limited to specific materials as long as the material has required capability for insulations. May be thermosoft plastic are preferred because softened plastic can fill the gap or void those are created during lamination process, and also can cover the edge of the current collector 1 and the separator 4 after the lamination process due to liquidity or plastic deformation. Examples of materials for the electron and ion insulator 5 include; Acrylic, such as Polyacrylic acids (PAA), Poly(methyl methacrylate) (PMMA); Acrylonitrile butadiene styrene (ABS); Polyamide (PA); Polyimide (PI); Polyamide-imide (PAI); Polycarbonate (PC); Polyoxymethylene (POM); Polyether ether ketone (PEEK); Polyetherimide (PEI); Polyethylene (PE); Polyethylene terephthalate (PET); Polyphenylene oxide (PPO); Polyphenylene sulfide (PPS); Polypropylene (PP); Polyvinyl chloride (PVC); Polyvinylidene fluoride (PVDF); Polytetrafluoroethylene (PTFE).

The insulator 5 can consist of multiple different materials. For example, as shown in FIG. 1, the vertical edge 5a does not need to be same materials as horizontal edge 5b.

The bipolar battery of the present invention is an improvement over currently existing bipolar batteries, because in the stacked cell 13, the current collector 1 of only the top layer and the bottom layer are exposed to the external environment. In the stacked cell 13, the edge of stack is fully covered by reinforcement made of insulator 5 and none of current collector 1, cathode layer 2, anode layer 3, nor separator 4 is exposed. Furthermore, in the stacked cell 13, the separator 4 area is larger than both cathode layer 2 and anode layer 3, but smaller than current collector 1. With this configuration, the short circuit due to ionic contact to another layer can be avoided while internal short circuit (cathode and anode) is avoided. Finally, in the stacked cell 13, none of current collector 1 nor separator 4 at different layers are touched.

### Air-Tight Pouch

The air-tight pouch 23 shown in FIGS. 15-18 plays a multifaceted role in the overall architecture of the proposed battery system. The air-tight pouch 23 comprises the current collector 21 and the insulator 20 and the pouch 23 serves several functions.

One of the primary roles of the air-tight pouch 23 is its robust protection against moisture intrusion. With air-tightness, it forms an impenetrable barrier, ensuring that no moisture makes its way into the stacked cells 13 housed within it. The significance of this feature cannot be overstated, as moisture ingress can be detrimental to the overall health, efficiency, and life of battery cells.

Apart from moisture protection, the pouch 23 has a salient feature that allows the creation of a vacuum environment for the stacked cell 13. By doing so, the environment within the pouch 23 remains inert, which is crucial for maintaining the chemical and physical integrity of the stacked cell 13. An inert environment ensures that there's no undesired chemical reaction that might otherwise compromise the performance or safety of the cell. Also, air-tight pouch 23 is the provision of atmospheric pressure to the stacked cell 13. This feature is ingeniously designed without the addition of any mechanical parts. Subjecting the battery to a modicum of pressure can have a plethora of benefits. It can aid in the reduction of internal resistance within the battery, thereby enhancing its cycling capabilities and overall efficiency.

After the vacuum lamination process, the air-tight pouch 23 is compatible with further densification of the stacked cell 13 using an isostatic press. This ensures that the cell components are compacted uniformly, ensuring optimum performance and longevity.

The air-tight pouch 23 plays a role in facilitating vacuum operations of the system. Since the current collector 21 of the airtight pouch 23 establishes an electrical connection with the stacked cell 13, it ensures that the cell operates seamlessly under vacuum conditions.

Insulator 20 can be the same material as the electron and ion insulator 5 used in stacked cell 13 or a different material. Any suitable material may be used, as long as it is not electron and ion conductive. It can be ceramics or plastic, especially if it has low permeability to moisture and oxygen. If the process requires pressurization of stack cell 13 using an air-tight pouch 23, plastic is especially desirable. This is because plastic is generally more pliable than ceramics, and some plastic deformation is expected during pressurization, and the risk of cracking is expected to be less than that of fragile ceramics.

Plastic materials for insulator 20 include Acrylic, such as Polyacrylic acids (PAA), Poly (methyl methacrylate) (PMMA); Acrylonitrile butadiene styrene (ABS); Polyamide (PA); Polyimide (PI); Polyamide-imide (PAI); Polycarbonate (PC); Polyoxymethylene (POM); Polyether ether ketone (PEEK); Polyetherimide (PEI); Polyethylene (PE); Polyethylene terephthalate (PET); Polyphenylene oxide (PPO); Polyphenylene sulfide (PPS); Polypropylene (PP); Polyvinyl chloride (PVC); Polyvinylidene fluoride (PVDF); Polytetrafluoroethylene (PTFE).

There can be a further different thermoplastic material 22 inside insulator 20. This is expected to improve the thermal weldability of insulator 20, reduce moisture permeability, and maintain a high vacuum. If thermoplastic material 22 is used, its welding temperature should be lower than that of insulator 20. This will improve the air-tightness of the air-tight pouch 23 while maintaining the mechanical strength of the insulator 20.

The thermoplastic layer 22 may consist of a single material or may be multilayered, consisting of multiple materials. For example, if it is a single material, Acrylic, such as Polyacrylic acids (PAA), Poly(methyl methacrylate) (PMMA); Acrylonitrile butadiene styrene (ABS); Polyamide (PA); Polyimide (PI); Polyamide-imide (PAI); Polycarbonate (PC); Polyoxymethylene (POM); Polyether ether ketone (PEEK); Polyetherimide (PEI); Polyethylene (PE); Polyethylene terephthalate (PET); Polyphenylene oxide (PPO); Polyphenylene sulfide (PPS); Polypropylene (PP); Polyvinyl chloride (PVC); Polyvinylidene fluoride (PVDF); Polytetrafluoroethylene (PTFE) are candidates for materials. In the case of multilayer, it is a combination of the above materials. For example, but not limited to, a PP/PE duplex structure, a PP/PE/PP triplex structure, a PE/PP/PE triplex structure, etc. are possible.

The position of thermoplastic layer 22 is not specified as long as sufficient sealing can be ensured at the junction of one insulator 20 and another insulator 20 as well as at a junction between an insulator 20 and current collector 21. For example, it may cover the entire surface of insulator 20, or it may cover only the junction between two insulators 20, or it may cover only the junction between current collector 21 and insulator 20.

The thickness of insulator 20 is not specifically limited, but a thinner layer may be preferred when higher capacity is required. For example, the thickness of insulator 20 is preferably between 1 μm to 2 mm, and is more preferably between 10 um to 1,000 um.

The current collector 21 of the air-tight pouch 23 may be composed of metal foil, a metal mesh, etc., and is especially preferably metal foil. Examples of metal constituting the current collector 1 include Cu, Ni, Cr, Au, Pt, Ag, Au, Al, Fe, Ti, Zn, Co and stainless steel. It can be the metal pure element, doped, alloy, or clad. The surface of the metal may also be covered with carbon or other material. This will ensure good adhesion with the cathode layer 2 and anode layer 3. In addition to metal, carbon can also be used for the current collector 21. Resin composites with an electron conductor (metal or carbon) as filler can also be used for the current collector 1. Possible carbon filler materials include acetylene black (AB), Ketjen black (KB), VGCF, carbon nanotubes, carbon nanohorns, and fullerenes.

Possible filler metals include stainless steel, Cu, Ni, Cr, Au, Pt, Ag, Au, Al, Fe, Ti, Zn, Co. The shape of the filler can be spherical, fibrous, needle-like, or hollow. When needle or fiber-shaped fillers are used, it may be effective to make them oriented. This is because the orientation controls the flow of electrons and makes it easier to interrupt the current in the event of an abnormality.

The thickness of the current collector 21 is not specifically limited, and for example, is preferably between 0.1 um to 2 mm, and is more preferably between 10 μm to 1,000 um.

The bipolar battery of the present invention is an improvement over currently existing bipolar batteries, because the air-tight pouch 23 is equipped with a current collector 21 and insulating surface 20. Furthermore, the air-tight pouch 23 allows the densification process of the stack and the air-tight pouch 23 is positioned inside a vacuum.

### Battery Casing

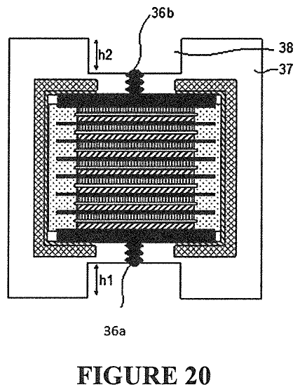

A bipolar battery is preferably accommodated in the battery casing as a whole stacked cell 13, as shown in FIGS. 19-20, to prevent external impact and environmental deterioration in use. Also, the casing enables one to handle the high voltage battery system during operation, installation to device, disassembly or maintenance.

The battery casing comprises a housing 37 that protects the stacked cell 13 (which may or may not be in air-tight pouch 23) from outside air and shock during actual use. In addition to the mechanical strength as required for a normal battery cell, housing 37 should be of a more insulating construction because stacked cell 13 has a higher voltage than a normal electrochemical cell. The material should be composed exclusively of electrically insulating materials. For example, a metal housing, such as those normally used for lithium-ion batteries or nickel-metal hydride, is not desirable, as there is concern that battery performance may be compromised by insulation breakdown.

Ceramics, rubber, or plastic are possible materials for housing 37. For ceramics, alumina, silica, or zirconia could be considered. For plastics, examples include, acrylic, such as Polyacrylic acids (PAA), Poly(methyl methacrylate) (PMMA); Acrylonitrile butadiene styrene (ABS); Polyamide (PA); Polyimide (PI); Polyamide-imide (PAI); Polycarbonate (PC); Polyoxymethylene (POM); Polyether ether ketone (PEEK); Polyetherimide (PEI); Polyethylene (PE); Polyethylene terephthalate (PET); Polyphenylene oxide (PPO); Polyphenylene sulfide (PPS); Polypropylene (PP); Polyvinyl chloride (PVC); Polyvinylidene fluoride (PVDF); and Polytetrafluoroethylene (PTFE).

To ensure the performance of stacked cell 13, preferably housing 37 is a sealed structure. For example, o-rings, welds, adhesives, etc. may be used to create a sealed structure. When sealing housing 37, the internal atmosphere should be considered from two perspectives. First, from the standpoint of the chemical stability of the battery itself, the concentration of moisture and oxygen should preferably be low. In addition, considering the possibility of high voltage in stacked cell 13, noble gases such as He, Ar, and Xe should be avoided, as these gases tend to cause dielectric breakdown under high voltage conditions. Considering the above, the atmosphere inside stacked cell 13 should be vacuum, N₂, SF₆, etc.

Housing 37 is equipped with electric connector 36 for electrical connection to stacked cell 13, characterized in that electric connector 36 is located at a height h lower than the top surface of housing 37. For this purpose, housing 37 has a concavity 38, into which electric connector 36 is placed. Such a structure reduces the risk of inadvertent external shorting of the stacked cell 13 during battery mounting, transport, and maintenance. The risk of external shorts due to creepage discharge is also reduced due to the distance of the electric connectors 36a and 36b along the housing 37.

Concavity 38 has a depth h and has an electric connector 36 in it. The shape of the concavity can be cylindrical, square, polygonal, hemispherical, or any other shape. Its low area should be as small as possible to reduce the risk of accidental external shorts. In other words, the concavity 38 should be larger than the electric connector 36, the connector to the external circuit, and the wiring, and should be large enough for maintenance, etc., but not unnecessarily larger than that. The depth h of concavity 38 is not specified, h should be as small as possible in terms of energy density, but larger is preferable in terms of insulation resistance and external short circuit risk. It can be designed accordingly depending on the battery voltage. For example, h could be between 2 mm and 100 mm, although it is not limited to this value. The depth h1 on the positive electrode side and h2 on the negative electrode side need not be the same. For example, one of them can be set to zero.

The shape of the electric connector 36 can be, for example, a screw (male or female thread), pin, foil, plate, needle, etc. Preferred materials are metals such as Cu, Al, and stainless steel.

The bipolar battery of the present invention is an improvement over currently existing bipolar batteries, because the battery casing is made of electron/ion insulator. The battery casing has electric connectors 36 that are placed in the concavity 38 to avoid shorting while handling/installation/disassembling/connection. Furthermore, the battery casing is sealed and inside is filled with inert such as vacuum, N₂, SF₆, but not with noble gases.

The method for manufacturing a high-voltage electrochemical cell comprises the following steps described below.

The method of manufacturing a high voltage electrochemical cell comprises the following steps: a process for protecting the edge of the current collector 1 by placing an insulator 5 on the edge of the current collector 1, a process for manufacturing an electrode layer by creating a free-standing film of cathode layer 2 and anode layer 3, a process for placing the free-standing film created by the above process at a position r inside the current collector 1 of the insulator 5 formed on the edge of the current collector 1, and a process for manufacturing a cathode layer 2 and anode layer 3. The process includes the electrode bonding process, in which the freestanding film created in the above process is placed at the position r inside the current collector 1 of the insulator 5 formed on the edge of current collector 1, cathode layer 2 and anode layer 3 are bonded to current collector 1, and the anode layer 3/current collector 1/cathode layer 2/anode layer 3 created in the above process is bonded to both sides or one side of cathode layer 2. Cathode layer 2 is formed on both sides or one side of cathode layer 2, and stack 6 or 7 or 8 is formed.

Cathode terminal stack 9 or 10 where only cathode layer 2 is formed on current collector 1 and anode terminal stack 11 or 12 where only anode layer 3 is formed on current collector 1 are created. Stack 11 or 12 is created where only anode layer 3 is formed on current collector 1. The individual processes are the same as the bipolar stack process, so the description here is omitted.

Stacks and terminal stacks created by the processes described above are stacked to obtain stacked cell 13 by compaction under high pressure. Air-tight pouch 23 may or may not be equipped at this time.

Stacked Cell 13 made by the above process is inserted into casing 30 and sealed. This process produces a high-voltage electrochemical cell.

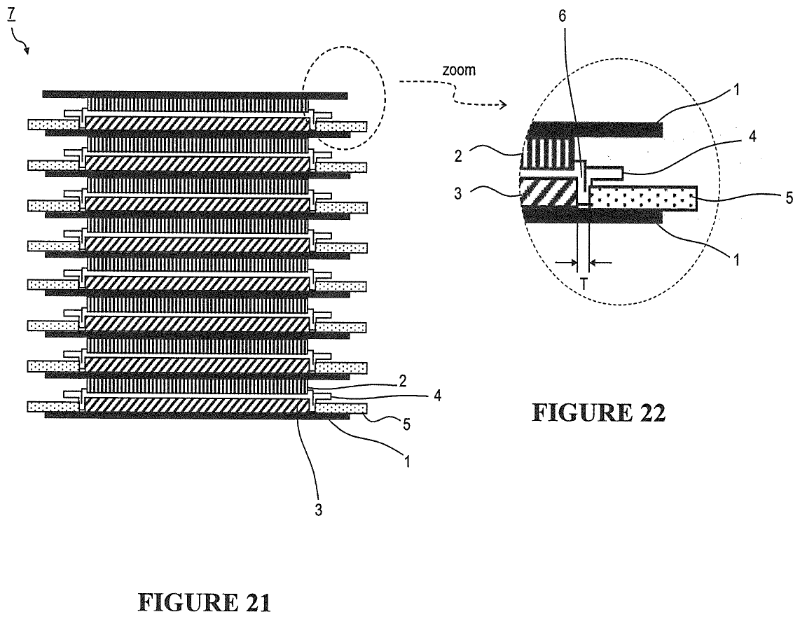

Referring to FIGS. 21-24, another embodiment of the stacked cell 13′ may be shown. Similar to the stacked cell 13, in the direction from high voltage side to low voltage, the stacked cell 13′ may consist of the current collector 1, the cathode layer 2, the separator 4, the anode layer 3, and another current collector 1. This configuration of elements 1, 2, 4, 3, 1, 2, . . . , 2, 4, 3, 1 may be repeated in this repeating order forming the stacked cell 13′. Each of the layers are formed so that none of the layers are contacting any of the other layers in/between the electric stacks.

The stacked cell 13′ may have an insulator 5. The insulator 5 may be made to enhance insulation between layers and thus enable the stacked cell 13′ to exhibit high voltage. The insulator 5 may be intricately formed on the current collector 1. The insulator 5 may be configured to ensure that any surface area of the current collector 1, which remains unoccupied by the cathode layer 2 or anode layer 3, is fully shielded.

In terms of its electrical properties, the insulator 5 may be built to be an exceptional insulator. The insulator 5 may be formed of a material that does not have conductivity of either electrons or ions. The insulator 5 may have an electric conductivity below 10⁻⁸ S/cm, with a stricter and more desirable threshold being below 10⁻¹⁰ S/cm. This ensures that the insulator 5 may perform at its optimum, providing maximum protection against any undesirable electrical currents.

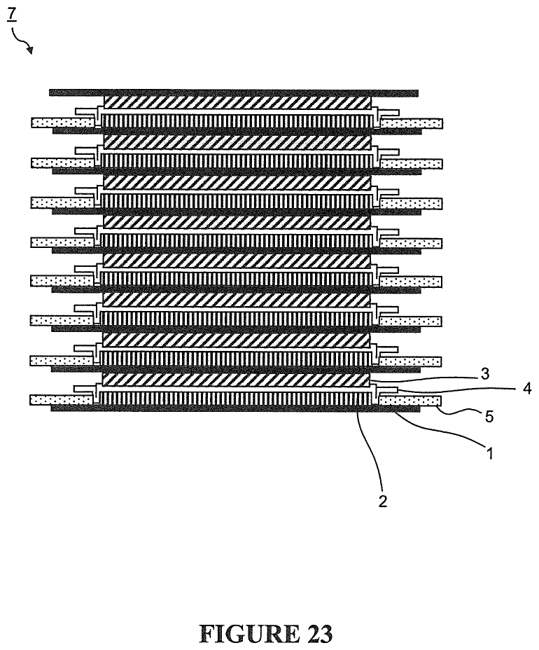

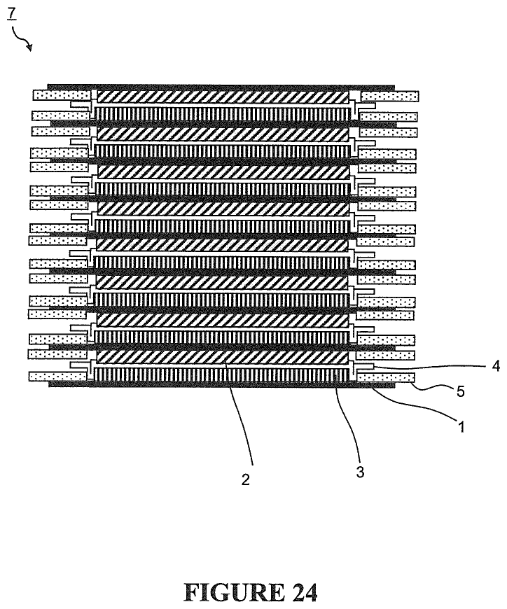

The position of the insulator 5 isn't bound by stringent restrictions. The guiding principle is that at least one of the exposed sides of the current collector 1 should be comprehensively shielded. For example, the insulator 5 may cover a portion of the exposed edge of one side of the current collector 1. In the embodiment shown in FIGS. 21 and 22, the insulator 5 may be formed on a surface 1A of each current collector 1 located adjacent the anode layer 3. As may be seen in FIG. 22, a height of the insulator 5 may be less than a height of the anode layer 3. Alternatively, the insulator 5 may be formed on a surface 1B of each current collector 1 located adjacent to the cathode layer 2 as may be seen in FIG. 23. As may be seen in FIG. 23, a height of the insulator 5 may be less than a height of the cathode layer 2. Alternatively, the insulator 5 may be formed on both surfaces 1A and 1B of each current collector 1 that is attached to both the cathode layer 2 and the anode layer 3 as may be seen in FIG. 24. As may be seen in FIG. 24, a height of the insulator 5 may be less than a height of the anode layer 3 and a height of the cathode layer 2.

The insulator 5 can be laminated onto the current collector 1, though this is not strictly necessary. Laminating the insulator 5 onto the current collector 1 may simplify the production process.

The insulator 5 may not completely seal the edges of the current collector 1. This configuration may allow gas to escape. Complete sealing of the edges of the current collector 1 may result in gas being trapped during the densification process, causing bubble formation. These bubbles may increase the impedance of the stacked cell 13′ and may accelerate degradation. Additionally, a complete seal may trap gases during prolonged cycling may lead to increased impedance and further degradation of the stacked cell 13′.

Moreover, leaving the edges unsealed can be beneficial in releasing stress during the pressuring step in the fabrication process of the stacked cell 13′, thereby avoiding breakage of the current collector 1 or the insulator 5.

While the exact area of the insulator 5 on the exposed surfaces of the current collector 1 may not be strictly defined, it may be essential for the insulator 5 to sufficiently cover any regions left exposed from the edge of the electrode active material layer. The key may be for the insulator 5 to insulate the surfaces of the current collector 1 electronically. However, it may be important to avoid the formation of the insulator 5 on exposed areas of either the cathode layer 2 or the anode layer 3. Such a placement could be problematic during the bonding process when creating the stacked cell 13′. Overlaps between the electrode and insulator 5 could create regions of uneven pressure. Such disparities in pressure could damage the current collector 1 or even the separator 4. Moreover, overlapping areas would naturally be bulkier than the mere edges of the electrode, compromising the insulating capabilities.

When applying the insulator 5, a gap T on the current collectors 1 may be formed. The distance of the gap T on the current collector 1 should be carefully calibrated to ensure insulation between layers. It is not limited by rigid parameters, but the distance should span a range from 0.0001% to 10% of the square root of S6, where S6 may represents the area of the anode layer 3, measured in cm². This may ensure a balanced design, offering optimum insulation while maintaining the structural integrity and performance of the stacked cell 13′. The gap or distance criteria between the anode layer 3 and insulator 5 may also be applicable to those between cathode layer 2 and insulator 5.

The materials used for the insulating 5 is not limited to specific materials as long as the material has required capability for insulations. The materials used may have been listed previously above. A thermosoft plastic may be preferred because softened plastic can fill the gap or void that may be created during lamination process, and may also cover the edge of current collector 1 and separator 4 after the lamination process due to liquidity or plastic deformation. Examples of the insulator 5 may include, but not limited to: Acrylic, such as Polyacrylic acids (PAA), Poly(methyl methacrylate) (PMMA); Acrylonitrile butadiene styrene (ABS); Polyamide (PA); Polyimide (PI); Polyamide-imide (PAI); Polycarbonate (PC); Polyoxymethylene (POM); Polyether ether ketone (PEEK); Polyetherimide (PEI); Polyethylene (PE); Polyethylene terephthalate (PET); Polyphenylene oxide (PPO); Polyphenylene sulfide (PPS); Polypropylene (PP); Polyvinyl chloride (PVC); Polyvinylidene fluoride (PVDF); Polytetrafluoroethylene (PTFE). The insulator 5 can consist of multiple different materials, such as combinations of the above listed.

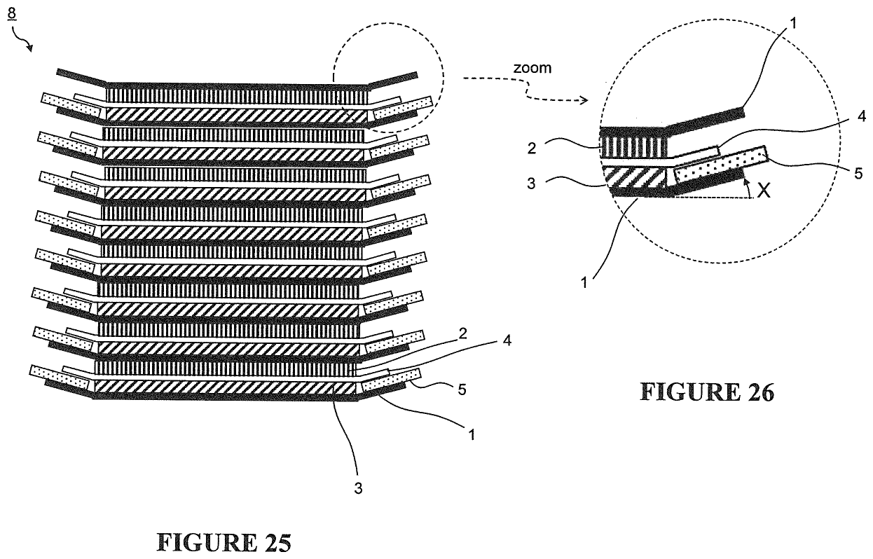

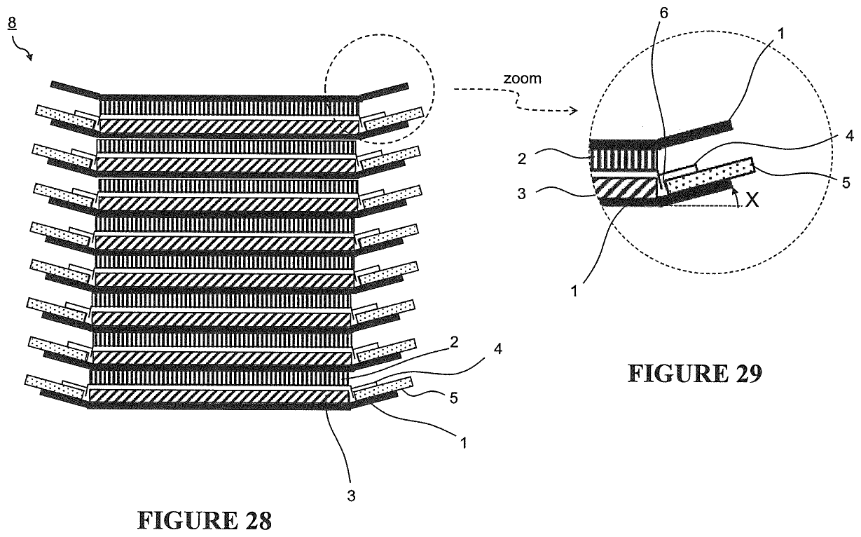

Referring to FIGS. 25-30, another embodiment of the stacked cell 13″ may be shown. Similar to the stacked cell 13 and 13′, in the direction from high voltage side to low voltage, the stacked cell 13′ may consist of the current collector 1, the cathode layer 2, the separator 4, the anode layer 3, and another current collector 1. This configuration of elements 1, 2, 4, 3, 1, 2, . . . 2, 4, 3, 1 may be repeated in this repeating order forming the stacked cell 13″. Each of the layers are formed so that none of the layers are contacting any of the other layers in/between the electric stacks.

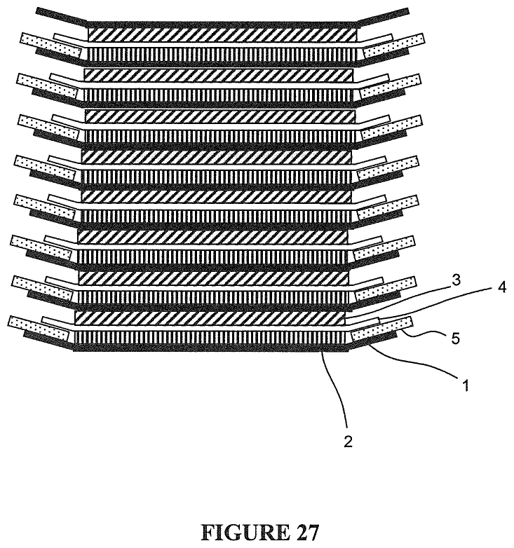

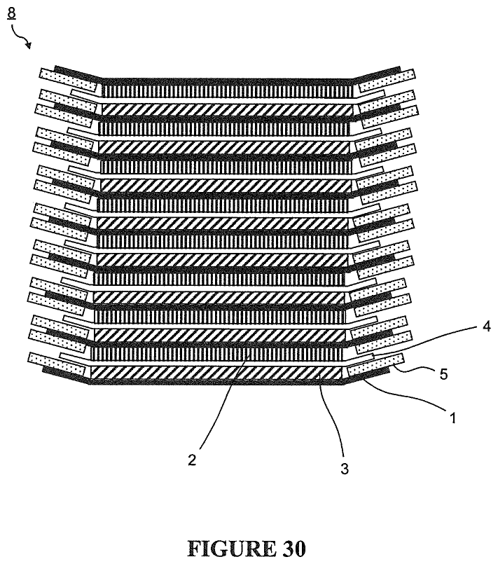

The exposed edge of the current collector 1 may be covered by the insulator 5. The insulator 5 does not have conductivity of either electrons or ions. The insulator 5 may cover a portion of the exposed edge of one side of the current collector 1. In the embodiment shown in FIGS. 25-26 and 28-29, the insulator 5 may be formed on a surface 1A of each current collector 1 located adjacent the anode layer 3. Alternatively, the insulator 5 may be formed on a surface 1B of each current collector 1 located adjacent to the cathode layer 2 as may be seen in FIG. 27. Alternatively, the insulator 5 may be formed on both surfaces 1A and 1B of each current collector 1 that is attached to both the cathode layer 2 and the anode layer 3 as may be seen in FIG. 30.

When the insulator 5 is attached on the exposed surface of current collector 1 adjacent the anode layer 3 as shown in FIGS. 25-26, the current collector 1 may be designed to bend up at the edge of the anode layer 3, generating an angled edge 1A for the stacked cell 13″. This angled edge 1A may enhance the structural integrity and ionic insulation of the cells by covering the separator 4 up from the external of cells. The insulator 5 may be laminated onto the current collector 1 and bends up together with the current collector 1, ensuring proper insulation and alignment within the stacked cell 13″ configuration.

The separator 4 may also bend up with the current collector 1. Notably, the separator 4 may be smaller than the current collector 1 and the insulator 5, ensuring that the separator 4 may not be exposed to the external surface. This design may minimize the risk of damage to the separator 4 and may maintain insulation integrity.

The angle X of the angled edge 1A against the base of the current collector 1, which may be laminated to the anode layer 3 may range from 3 degrees to 90 degrees. More specifically, the angle X may range from 5 degrees to 80 degrees. The angled edges 1A may be beneficial for improving the insulation between each layer and preventing electrical short circuits.

If the insulator 5 is attached to the cathode side of surface of the current collectors 1 as may be seen in FIG. 27, the same criteria used between the anode layer 3 and insulator 5 is applicable to those between the cathode layer 2 and insulator 5. Also, if the insulator 5 is laminated on both side of the current collector 1 as may be seen in FIG. 30, the angle X may range from 3 degrees to 90 degrees. More specifically, the angle X may range from 5 degrees to 80 degrees.

In the stacked cell 13″, like the stacked cell 13′, a gap T on the current collectors 1 may be formed. The separator 4 may be applied and is squeezed in the gap T between the cathode layer 2 or anode layer 3 when forming the angled edge 1A as may be seen FIG. 30. With the squeezed separator 4, the electric insulation of the stacked cell 13″ may be improved since the anode layer 3 (or cathode layer 2 or both) may be covered by the separator 4.

The stacked cell 13″ has been formulated and test as described below. The stacked cell 13″ formed may satisfy the area relationship of:
S1>S3>S4>S2>S5≥S6 or S1>S3>S4>S2>S6≥S5 where:
   S1=area generated by outer edge of insulator 5
   S2=area generated by inner edge of insulator 5
   S3=area of current collector 1
   S4=area of separator 4
   S5=area of cathode layer 2
   S6=area of anode layer 3

A 40 μm thick carbon coated Aluminum foil (area S3) may have been prepared as the current collector 1, and a 25 μm thick Polyetherimide (PEI) film, which may equip adhesive Polyisobutene (PIB), may be attached on to the one of the carbon coated Aluminum foil as an insulator 5. The area generated by outer edge of insulator 5, and that of its inner edge are S1 and S2, respectively.

The cathode layer 2 may be fabricated of a powder of Cathode Active Material (LiNi_{1/3}Co_{1/3}Mn_{1/3}O₂, MTI corporation), solid electrolyte (SSE-10, NEI) and PTFE (Daikin America) mixed in the ratio of 87:12:1 (wt %). Then the mixture was extended to the sheet with the thickness 120 μm to form the cathode layer 2. The area of the cathode layer 2 is S5.

The anode layer 3 may be fabricated of a powder of Anode Active Material (Li₄Ti₅O₁₂, MSE supplies LLC), solid electrolyte (SSE-10, NEI), carbon black (Imerys) and PTFE (Daikin America) mixed in the ratio of 80:15:1:4 (wt %). Then the mixture was extended to the sheet with the thickness 300 μm to form the anode layer 3. The area of anode layer 3 is S6.

The separator 4 may be fabricated of a powder of solid electrolyte (SSE-10, NEI) and PTFE (Daikin America) mixed in the ratio of 97:3 (wt %). Then the mixture was extended to the sheet with the thickness 120 μm to form the separator 4. The area of the separator 4 is S4.

The cells of the stacked cell 13″ may be fabricated with stacking the unit cell consisting of the current collector 1, anode layer 3, separator 4, and cathode layer 2. The layers may be stacked in the order of current collector 1, anode layer 3, separator 4, cathode layer 2, current collector 1. This configuration of elements 1, 2, 4, 3, 1, 2, . . . 2, 4, 3, 1 may be repeated in this repeating order. In total, 10 of electrochemical cells may be stacked forming the bipolar stacked cell 13″. The last current collector 1 touching to only the cathode layer 2 may not have the insulator on the surface. The area of S1, S2, S3, S4, S5 and S6 is listed on the table 1 below. The area satisfies S1>S3>S4>S2>S6≥S5.

The angled edge 1A edge of the stacked cell 13″ may be bent to have the angle (X) of 80 degree.

TABLE 1

| S1/cm² | S2/cm² | S3/cm² | S4/cm² | S5/cm² | S6/cm² |
|---|---|---|---|---|---|
| 9.07 | 6.15 | 8.04 | 7.07 | 3.80 | 4.91 |

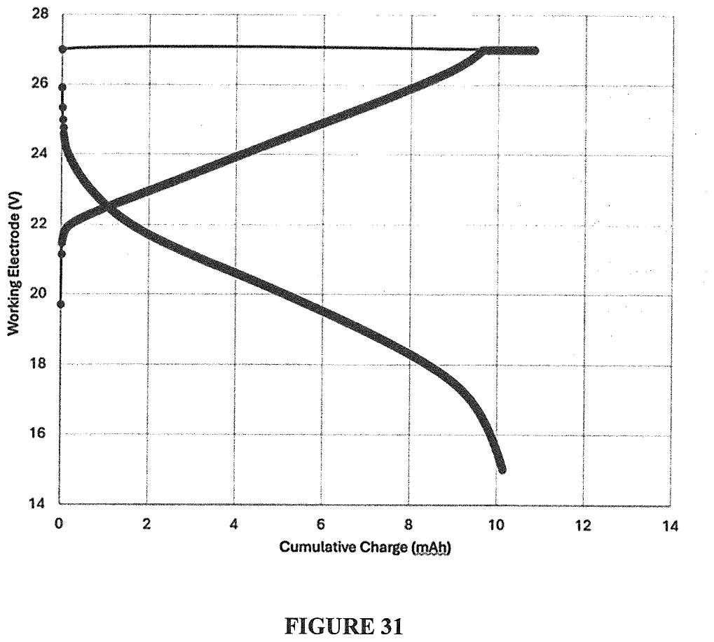

The bipolar stacked cell 13″ may be charged and discharged at a current density of 1.0 mA/cm² in the voltage range of 15 V to 27 V. The bipolar stacked cell 13″ was able to charge and discharge without any ionic or electronic short. The charge and discharge profile may be shown in FIG. 31.

As a comparison to the example above, the stacked cell 13″ was formulated and tested again as described below. In this embodiment, the stacked cell 13″ satisfied the same area relationships as described above. The current collector 1 was formed in the same manner as in the previous test embodiment except for the thickness of Polyetherimide (PEI) film. In this test embodiment, a 250 μm thick PEI film, which equips adhesive Polyisobutene (PIB), was attached on to one of the carbon coated Aluminum foil as an insulating frame. The remaining structure of the stacked cell 13″ remained the same. Thus, the fabrication of the cathode layer 2, the anode layer 3, the separator 4, and the fabrication of the stacked cell 13″ was the same as in the previous test embodiment.

In this test embodiment, the edge of the stacked cell 13″ was not bent. Thus, the angle X was at 0°.

TABLE 2

| S1/cm² | S2/cm² | S3/cm² | S4/cm² | S5/cm² | S6/cm² |
|---|---|---|---|---|---|
| 9.07 | 6.15 | 8.04 | 7.07 | 3.80 | 4.91 |

TABLE 3

| | | Coulombic efficiency |
|---|---|---|
| | X (degree) | at 2^{nd} cycle (%) |
| Example | 80 | 94.4 |
| Comparative Example | 0 | 64.9 |

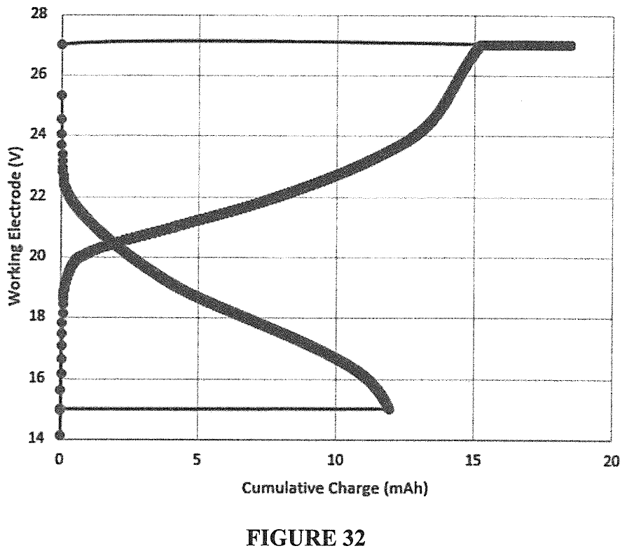

The bipolar stacked cell 13″ was charged and discharged at a current density of 1.0 mA/cm² in the voltage range of 15 V to 27 V. However, it shows low coulombic efficiency (64.9%) at the 2^{nd} cycle. Also, the voltage profile is lower than the previous test embodiment although it had the same number of stacks. Low coulombic efficiency and overall low voltage profile are the indication of short happening in the cell. The charge and discharge profile may be shown in FIG. 32.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public.

1. A bipolar stacked battery, comprising:
a plurality of bipolar electrodes, wherein each of the bipolar electrodes comprises:
a current collector;
a cathode layer containing a cathode active material formed on a first surface of the current collector;
an anode layer containing an anode active material formed on a second surface of the current collector;
a separator layer formed on the cathode layer and the anode layer, wherein the separator layer extends past opposing side edges of the cathode layer and the anode layer; and
an insulator formed on exposed side edges on at least one side of the current collector and extending past the current collector;
a pair of terminal stacks, wherein one of the pair of terminal stacks is formed at a higher voltage side of the bipolar stacked battery and a second of the pair of terminal stacks is formed on a lower voltage side of the bipolar stacked battery.

2. The bipolar staked battery of claim 1, wherein the insulator covers all exposed surfaces of the current collector, the cathode layer, the anode layer, and the separator of the plurality of bipolar electrodes.

3. The bipolar staked battery of claim 1, wherein the pair of terminal stacks comprises:
a cathode terminal stack formed on a higher voltage side of the bipolar stacked battery, the cathode terminal stack comprising:
a cathode terminal current collector; and
a cathode terminal layer containing a cathode terminal active material formed on a first surface of the cathode terminal current collector; and
an anode terminal stack formed at a lower voltage side of the bipolar stacked battery, the anode terminal stack comprising:
an anode terminal current collector; and
an anode terminal layer containing an anode terminal active material formed on a first surface of the anode terminal current collector.

4. The bipolar staked battery of claim 3, wherein the insulator covers all exposed surfaces of the current collector, the cathode layer, the anode layer, and the separator of the plurality of bipolar electrodes, the exposed surfaces of the cathode terminal layer and exposed areas on the first surface of the cathode terminal current collector, and the exposed surfaces of the anode terminal layer and exposed areas on the first surface of the anode terminal current collector.

5. The bipolar staked battery of claim 1, comprising an air-tight pouch surrounding the plurality of bipolar electrodes.

6. The bipolar staked battery of claim 5, comprising a battery casing surrounding the plurality of bipolar electrodes and the air-tight pouch, wherein an electric connector is positioned within a concavity of the battery casing.

7. The bipolar staked battery of claim 1, wherein opposing side edges of the current collector of the plurality of bipolar electrodes are bent upwards or downwards with respect to the plane of the current collector.

8. The bipolar staked battery of claim 7, wherein the opposing side edges of the current collector of the plurality of bipolar electrodes are bent upwards at an angle ranging from 5° to 85°.

9. The bipolar staked battery of claim 1, comprising a gap formed between the anode layer and the insulator, the insulator formed on exposed areas on the second surface of the current collector where the anode layer is formed, wherein a section of the separator is positioned within the gap.

10. The bipolar staked battery of claim 1, comprising a gap formed between the cathode layer and the insulator, the insulator formed on exposed areas on the first surface of the current collector where the cathode layer is formed, wherein a section of the separator is positioned within the gap.

11. The bipolar staked battery of claim 1, comprising:
a first gap formed between the anode layer and the insulator, the insulator formed on exposed areas on the first surface of the current collector where the anode layer is formed; and
a second gap formed between the cathode layer and the insulator, the insulator formed on exposed areas on the second surface of the current collector where the cathode layer is formed, wherein the separator is positioned within the second gap.

12. The bipolar staked battery of claim 9, wherein a distance of the gap ranges from 0.0001% to 10% of the square root of an area of the anode layer measured in cm².

13. The bipolar staked battery of claim 9, wherein opposing side edges of the current collector of the plurality of bipolar electrodes are bent upwards or downwards with respect to the plane of the current collector.

14. The bipolar staked battery of claim 10, wherein opposing side edges of the current collector of the plurality of bipolar electrodes are bent upwards or downwards with respect to the plane of the current collector.

15. The bipolar staked battery of claim 11, wherein opposing side edges of the current collector of the plurality of bipolar electrodes are bent upwards or downwards with respect to the plane of the current collector.

16. The bipolar staked battery of claim 13, wherein the opposing side edges of the current collector of the plurality of bipolar electrodes are bent upwards at an angle ranging from 5° to 85°.

17. A bipolar stacked battery, comprising:
a plurality of bipolar electrodes, wherein each of the bipolar electrodes comprises:
a current collector;
a cathode layer containing a cathode active material formed on a first surface of the current collector;
an anode layer containing an anode active material formed on a second surface of the current collector;
a separator layer formed on the cathode layer and the anode layer, wherein the separator layer extends past opposing side edges of the cathode layer and the anode layer;
an insulator formed on exposed side edges on at least one side of the current collector and extending past the current collector;
a gap formed between at least one of the anode layer and the insulator, the insulator formed on exposed areas on the first surface of the current collector where the anode layer is formed, the separator is positioned within the gap between the anode layer and the insulator or between the cathode layer and the insulator, the insulator formed on exposed areas on the second surface of the current collector where the cathode layer is formed, wherein the separator is positioned within the gap between the cathode layer and the insulator.

18. The bipolar staked battery of claim 17, wherein a distance of the gap ranges from 0.0001% to 10% of the square root of an area of the anode layer measured in cm².

19. The bipolar staked battery of claim 17, wherein opposing side edges of the current collector of the plurality of bipolar electrodes are bent upwards or downwards with respect to the plane of the current collector.

20. The bipolar staked battery of claim 19, wherein the opposing side edges of the current collector of the plurality of bipolar electrodes are bent upwards at an angle ranging from 5° to 85°.
